(19) United States
(12) Patent Application Publication
(10) Pub. No.: US 2019/0090527 A1
(43) Pub. Date: Mar. 28, 2019

(54) EDIBLE CANNABINOID COMPOSITIONS

(71) Applicant: ebbu Inc., Evergreen, CO (US)

(72) Inventor: Kurt Aron LEVY, Dillon, CO (US)

(21) Appl. No.: 16/144,376

(22) Filed: Sep. 27, 2018

Related U.S. Application Data
(60) Provisional application No. 62/564,647, filed on Sep. 28, 2017.

(51) Int. Cl. A23L 33/105; A23L 29/30; A23L 29/00; A23P 20/10; A23P 10/30

(52) U.S. Cl. CPC A23L 33/105; A23L 29/30; A23L 29/015; A23L 29/035; A23P 20/105; A23P 10/30; A23V 2250/15; A23V 2250/628; A23V 2250/606; A23V 2250/032; A23V 2250/708; A23V 2250/712; A23V 2200/15; A23V 2002/00

(57) ABSTRACT

Disclosed herein is a cannabis composition with a spherical design. The composition comprises an acid and base for facilitating the transmucosal absorption of a cannabinoid into the body. In some embodiments, the compositions comprise various combinations of cannabinoids and/or terpenes.

### TECHNICAL FIELD

This disclosure relates to the cannabis industry. In particular, this disclosure relates to edible compositions.

### BACKGROUND

The word “cannabis” refers to a genus of flowering plants. Plants of genus cannabis include several species, including Cannabis sativa, Cannabis indica, and Cannabis ruderalis. There is a long history of cultivating plants of genus cannabis for hemp fibers, seeds and seed oils, medicinal purposes, and recreational activities.

According to some accounts, cannabis is composed of at least 483 known chemical compounds, which include cannabinoids, terpenoids, flavonoids, nitrogenous compounds, amino acids, proteins, glycoproteins, enzymes, sugars and related compounds, hydrocarbons, alcohols, aldehydes, ketones, acids, fatty acids, esters, lactones, steroids, terpenes, non-cannabinoid phenols, vitamins, and pigments.

Cannabinoids are of particular interest for research and commercialization. Most extractions of cannabis plant matter aim to extract cannabinoids, particularly tetrahydrocannabinol (THC). THC is useful for relieving pain, treating glaucoma, and relieving nausea. THC is also gaining immense popularity as a recreational drug substance. Usually, cannabinoids are extracted from the cannabis plant as part of a crude mixture, combined with other chemical compounds found in the cannabis plant.

Some of the less common cannabinoids have neither been isolated nor studied alone or in any combination. For example, THC, CBN, CBC, CBGV, CBGVA, CBDV, CBCV, THCV, CBDVA, CBGA, CBCV, CBCVA CBL, CBG, CBD. Additionally, there has been little or no work developing compositions having purposefully engineered, repeatable, consistent, and dependable ratios of cannabinoids.

Many compositions and methods have been developed for administering cannabinoids. The most common and well-known method is igniting dried cannabis material and inhaling the smoke. This method poses several problems. First, the inhalation of smoke can harm the lungs and lead to several other health issues. In particular, heat can cause unwanted chemical changes creating unwanted compounds and byproducts. Second, most dried cannabis is not administrable in precise, controlled doses. Many cannabis plants are bred to have certain ratios and concentrations of cannabinoids but rarely in the exact amounts needed or wanted.

Another method of administering cannabinoids is to make food products, e.g., baked goods, candies, etc., with cannabis plant material, oil and/or extract. While ingesting cannabinoids does not involve the inhalation of smoke, the issue of dosage persists. Without testing each plant sample, it is almost impossible to know the cannabinoid concentration in cannabis plants extracts and oils.

Other persisting issues with conventional methods of cannabinoid administration include onset time, absorption, duration of action, etc. These issues are rarely addressed and are only now receiving attention.

Other methods of administration include transdermal absorption. Disclosures by Nicole Smith on behalf of Mary's Medicinals LLC, U.S. Patent Application Publication Nos. US 2015/0126595 A1 and US 2015/0297556 A1, disclose compositions and methods for transdermal delivery of cannabinoids into the bloodstream.

While these disclosures allow the absorption of cannabinoids into the bloodstream through the skin, they require the use of a patch. Using a patch poses several problems. First, patches can irritate the skin. Second, having to adhere a composition onto a patch poses issues of patch material, the consistency of the composition, etc. Third, the composition may not absorb into the skin entirely. Fourth, the patch does not provide much versatility allowing for only a single method of use.

There exists an unmet need for a fast and efficient method of administering cannabinoids by mouth. Applicants have discovered that transmucosal absorption solves several problems. Transmucosal absorption allows for quicker delivery to the body through the bloodstream. Transmucosal absorption also allows precise doses into the body without the use of external devices or methods. There exists a need for transmucosal absorption of cannabinoids. There exists a need for compositions formulated for transmucosal absorption through the mouth and upper gastrointestinal, providing rapid and consistent delivery of cannabinoids and/or terpenes into the body.

### DETAILED DESCRIPTION

Disclosed herein are new edible compositions comprising cannabinoids. Disclosed herein are new edible compositions of spherical form. Disclosed herein are new edible compositions comprising cannabinoids and terpenes in spherical form.

Disclosed herein are new compositions for transmucosal absorption. In one embodiment, the compositions disclosed herein are designed for administering the compositions via a person's mouth and rapidly dissolving and dispersing the compositions through the effervescence of the compound. In one embodiment, the effervescent assists with distributing the cannabinoid into the mucus membrane allowing for the absorption of the cannabinoid. In one embodiment, the compositions comprise a terpene.

Disclosed herein is a new composition comprising:
a shell; wherein said shell comprises a sugar and a flavoring agent; and
a core; wherein said core comprises an acid, a base, Vitamin E TPGS, and a cannabinoid.

As used herein, the term “shell” refers to an outer layer, which surrounds and encloses an inner portion of matter. In one embodiment, the matter is air. In one embodiment, the matter is another shell. In one embodiment, the matter is a core. In one embodiment, the shell completely surrounds the core. In one embodiment, the shell is perforated.

As used herein, the term “core” refers to an inner portion of matter or component. In one embodiment, the core is solid. In one embodiment, the core is a liquid. In one embodiment, the core is a gel. In one embodiment, the shell is a gas. In one embodiment, the core is hollow. In one embodiment, the core comprises a first cannabinoid. In one embodiment, the core comprises a second cannabinoid. In one embodiment, the core comprises a first terpene. In one embodiment, the core comprises a second terpene. In one embodiment, the core comprises a first cannabinoid and a first terpene.

As used herein, the term “sugar” refers to a compound used by organisms to store energy. Sugar is often used in food products as a sweetener and may provide other benefits, e.g., preservative, texture modifier, flavoring agent, bulking agent, etc. In one embodiment, the sugar is a carbohydrate. In one embodiment, the sugar is a monosaccharide. In one embodiment, the sugar is a disaccharide. In one embodiment, the sugar is an oligosaccharide. In one embodiment, the sugar is a short composed of carbon, hydrogen, and oxygen. In one embodiment, the sugar has the formula CnH2nOn, wherein n is an integer. In one embodiment, n is 3. In one embodiment, n is 4. In one embodiment, n is 5. In one embodiment, n is 6. In one embodiment, n is 7.

Within the context of this disclosure, the term sugar may also refer to a number of naturally occurring or synthetic compounds imparting sweetness. For example, maltodextrin, sorbitol, stevia, mannitol, aspartame, sucralose, isomalt, xylitol, etc.

In one embodiment, the sugar is fructose. In one embodiment, the sugar is sucrose. In one embodiment, the compositions disclosed herein comprise more than one sugar. In one embodiment, the compositions disclosed herein comprise sucrose and fructose.

In one embodiment, the composition disclosed herein comprise a dry weight ratio of sucrose to fructose of about 1:1 to 1:25.

In one embodiment, the composition disclosed herein comprise a dry weight ratio of sucrose to fructose of about 1:5 to 1:20.

In one embodiment, the composition disclosed herein comprise a dry weight ratio of sucrose to fructose of about 1:10 to 1:15.

In one embodiment, the composition disclosed herein comprise a dry weight ratio of sucrose to fructose of about 1:1 to 25:1.

In one embodiment, the composition disclosed herein comprise a dry weight ratio of sucrose to fructose of about 25:1 to 20:1.

In one embodiment, the composition disclosed herein comprise a dry weight ratio of sucrose to fructose of about 10:1 to 15:1.

As used herein, the term “flavoring agent” refers to a compound or mixture of compounds imparting or modifying a taste. In one embodiment, the flavoring agent is sugar. In one embodiment, the flavoring agent is salt. In one embodiment, the flavoring agent is a bitter blocker. In one embodiment, the flavoring agent is vanilla. In one embodiment, the flavoring agent is citrus. In one embodiment, the flavoring agent is lemon. In one embodiment, the flavoring agent is orange. In one embodiment, the flavoring agent is chocolate. In one embodiment, the flavoring agent is fruit. In one embodiment, the flavoring agent is strawberry. In one embodiment, the flavoring agent is banana. In one embodiment, the flavoring agent is cherry. In one embodiment, the flavoring agent is blueberry. In one embodiment, the flavoring agent is a terpene. In one embodiment, the flavoring agent is limonene. In one embodiment, the flavoring agent is linalool. In one embodiment, the flavoring agent is Beta-Caryophyllene.

In one embodiment, the flavoring agent comprises about 1-10% of the shell by mass percent.

In one embodiment, the flavoring agent comprises about 2-9% of the shell by mass percent.

In one embodiment, the flavoring agent comprises about 3-8% of the shell by mass percent.

In one embodiment, the flavoring agent comprises about 4-7% of the shell by mass percent.

In one embodiment, the flavoring agent comprises about 5-6% of the shell by mass percent.

Within the context of this disclosure, other compounds may be classified as a flavoring agent, e.g., an acid may also be a flavoring agent.

As used herein, the term “acid” refers to a chemical species donating protons or hydrogen ions and/or accepting electrons. In one embodiment, the acid is a compound with a pH below 7. In some embodiments, a compound may have both acidic and basic qualities.

As used herein, the term “base” refers to a chemical species accepting protons or hydrogen ions and/or donating electrons. In one embodiment, the base is a compound with a pH above 7. In some embodiments, a compound may have both acidic and basic qualities.

As used herein, the term “Vitamin E TPGS” refers to a product formed by the esterification of Vitamin E succinate with polyethylene glycol 1000 resulting in the following structural formula:

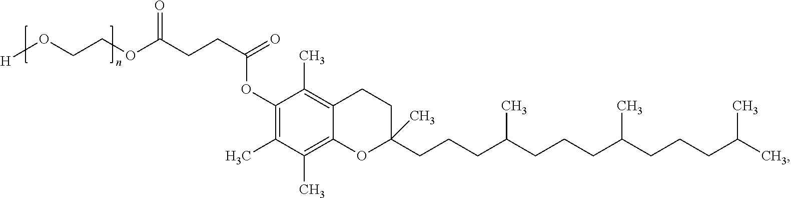

wherein “n” is an integer.

Within the context of this disclosure, Vitamin E TPGS is formulated with compounds found in the cannabis plant to increase the solubility and bioavailability of poorly water-soluble lipophilic compounds.

As used herein, the term “cannabinoid” refers to a compound belonging to a class of secondary compounds commonly found in plants of genus cannabis. In one embodiment, the cannabinoid is found in a plant, e.g., a plant of genus cannabis, and is sometimes referred to as a phytocannabinoid. In one embodiment, the cannabinoid is found in a mammal, sometimes called an endocannabinoid. In one embodiment, the cannabinoid is made in a laboratory setting, sometimes called a synthetic cannabinoid. In one embodiment, the cannabinoid acts upon a cellular receptor, such as a G-coupled protein receptor (e.g., a serotonin receptor, a cannabinoid receptor, TRPV1, an opioid receptor, etc.) thereby causing a response on the brain or body. In one embodiment, the cannabinoid affects the activity of other compounds at one or more receptors by acting as an agonist, partial agonist, inverse agonist, antagonist, etc.

In one embodiment, the purified cannabinoid is chosen from THC, D9-THC, D8-THC, THCA, THCV, D8-THCV, D9-THCV, THCVA, CBD, CBDA, CBDV, CBDVA, CBC, CBCA, CBCV, CBCVA, CBG, CBGA, CBGV, CBGVA, CBN, CBNA, CBNV, CBNVA, CBND, CBNDA, CBNDV, CBNDVA, CBE, CBEA, CBEV, CBEVA, CBL, CBLA, CBLV, or CBLVA.

In one embodiment, the compositions disclosed herein comprise a second cannabinoid.

In one embodiment, the core comprises about 5-30% of a cannabinoid by mass percent.

In one embodiment, the core comprises about 10-25% of a cannabinoid by mass percent.

In one embodiment, the core comprises about 15-20% of a cannabinoid by mass percent.

In one embodiment, the compositions disclosed herein comprise a terpene.

As used herein, the term “terpene” refers to a compound built on an isoprenoid structure or produced by combining isoprene units, 5 carbon structures. Terpenes are also associated with producing smell in plants where terpenes are part of a class of secondary compounds. In one embodiment, the terpene is a hydrocarbon.

Within the context of this disclosure, the term “terpene” does not necessarily require 5 carbons or multiples of 5 carbons. It is understood that a reaction with isoprene units does not always result in a terpene comprising all the carbon atoms.

Within the context of this disclosure, the term “terpene” includes Hemiterpenes, Monoterpenols, Terpene esters, Diterpenes, Monoterpenes, Polyterpenes, Tetraterpenes, Terpenoid oxides, Sesterterpenes, Sesquiterpenes, Norisoprenoids, or their derivatives. As well as isomeric, enantiomeric, or optically active derivatives.

Derivatives of terpenes include terpenoids, hemiterpenoids, monoterpenoids, sesquiterpenoids, sesterterpenoid, sesquarterpenoids, tetraterpenoids, triterpenoids, tetraterpenoids, polyterpenoids, isoprenoids, and steroids.

Within the context of this disclosure, the term terpene includes the α-(alpha), β-(beta), γ-(gamma), oxo-, isomers, stereoisomers or any combinations thereof.

Examples of terpenes within the context of this disclosure include: 7,8-dihydro-alpha-ionone, 7,8-dihydro-beta-ionone, Acetanisole, Acetic Acid, Acetyl Cedrene, Anethole, Anisole, Benzaldehyde, Bergamotene (Alpha-cis-Bergamotene) (Alpha-trans-Bergamotene), Bisabolol (Beta-Bisabolol), Alpha, Bisabolol, Borneol, Bornyl Acetate, Butanoic/Butyric Acid, Cadinene (Alpha-Cadinene) (Gamma-Cadinene), Cafestol, Caffeic acid, Camphene, Camphor, Capsaicin, Carene (Delta-3-Carene), Carotene, Carvacrol, Dextro-Carvone, Laevo-Carvone, Caryophyllene (Beta-Caryophyllene), Caryophyllene oxide, Cedrene (Alpha-Cedrene) (Beta-Cedrene), Cedrene Epoxide (Alpha-Cedrene Epoxide), Cedrol, Cembrene, Chlorogenic Acid, Cinnamaldehyde, Alpha-amyl-Cinnamaldehyde, Alpha-hexyl-Cinnamaldehyde, Cinnamic Acid, Cinnamyl Alcohol, Citronellal, Citronellol, Cryptone, Curcumene (Alpha-Curcumene) (Gamma-Curcumene), Decanal, Dehydrovomifoliol, Diallyl Disulfide, Dihydroactinidiolide, Dimethyl Disulfide, Eicosane/Icosane, Elemene (Beta-Elemene), Estragole, Ethyl acetate, Ethyl Cinnamate, Ethyl maltol, Eucalyptol/1,8-Cineole, Eudesmol (Alpha-Eudesmol) (Beta-Eudesmol) (Gamma-Eudesmol), Eugenol, Euphol, Farnesene, Farnesol, Fenchol (Beta-Fenchol), Fenchone, Geraniol, Geranyl acetate, Germacrenes, Germacrene B, Guaia-1(10),11-diene, Guaiacol, Guaiene (Alpha-Guaiene), Gurjunene (Alpha-gurjunene), Herniarin, Hexanaldehyde, Hexanoic Acid, Humulene (Alpha-Humulene) (Beta-Humulene), Ionol (3-oxo-alpha-ionol) (Beta-Ionol), Ionone (Alpha-Ionone) (Beta-Ionone), Ipsdienol, Isoamyl Acetate, Isoamyl Alcohol, Isoamyl Formate, Isoborneol, Isomyrcenol, Isopulegol, Isovaleric Acid, Isoprene, Kahweol, Lavandulol, Limonene, Gamma-Linolenic Acid, Linalool, Longifolene, Alpha-Longipinene, Lycopene, Menthol, Methyl butyrate, 3-Mercapto-2-Methylpentanal, Mercaptan/Thiols, Beta-Mercaptoethanol, Mercaptoacetic Acid, Allyl Mercaptan, Benzyl Mercaptan, Butyl Mercaptan, Ethyl Mercaptan, Methyl Mercaptan, Furfuryl Mercaptan, Ethylene Mercaptan, Propyl Mercaptan, Thenyl Mercaptan, Methyl Salicylate, Methylbutenol, Methyl-2-Methylvalerate, Methyl Thiobutyrate, Myrcene (Beta-Myrcene), Gamma-Muurolene, Nepetalactone, Nerol, Nerolidol, Neryl acetate, Nonanaldehyde, Nonanoic Acid, Ocimene, Octanal, Octanoic Acid, P-Cymene, Pentyl butyrate, Phellandrene, Phenylacetaldehyde, Phenylethanethiol, Phenylacetic Acid, Phytol, Pinene, Beta-Pinene, Propanethiol, Pristimerin, Pulegone, Quercetin, Retinol, Rutin, Sabinene, Sabinene Hydrate, cis-Sabinene Hydrate, trans-Sabinene Hydrate, Safranal, Alpha-Selinene, Alpha-Sinensal, Beta-Sinensal, Beta-Sitosterol, Squalene, Taxadiene, Terpin hydrate, Terpineol, Terpine-4-ol, Alpha-Terpinene, Gamma-Terpinene, Terpinolene, Thiophenol, Thujone, Thymol, Alpha-Tocopherol, Tonka Undecanone, Undecanal, Valeraldehyde/Pentanal, Verdoxan, Alpha-Ylangene, Umbelliferone, or Vanillin.

In one embodiment, the terpene is chosen from Limonene, Nerolidol, Beta-Myrcene, Linalool, Alpha-Caryophyllene, Beta-Caryophyllene, Alpha-Pinene, Beta-Pinene, Alpha-Bisabolol, Delta-3-Carene, Borneol, p-Cymene, Eucalyptol, Alpha-Humulene, Alpha-Terpineol, Terpinolene, Pulegone, Camphene, or Geraniol.

In one embodiment, the core comprises about 5-30% of a terpene by mass percent.

In one embodiment, the core comprises about 10-25% of a terpene by mass percent.

In one embodiment, the core comprises about 15-20% of a terpene by mass percent.

In one embodiment, the core comprises about 5-30% of a cannabinoid and a terpene by mass percent.

In one embodiment, the core comprises about 10-25% of a cannabinoid and a terpene by mass percent.

In one embodiment, the core comprises about 15-20% of a cannabinoid and a terpene by mass percent.

In one embodiment, the cannabinoid is purified. In one embodiment, the terpene is purified. In one embodiment, the compositions disclosed herein comprise a mixture of purified and unpurified compounds.

As used within the context of this application, the term “purified” means extracted, isolated, and/or separated from other compounds, formulations, compositions, matter, and/or mass. In one embodiment, the term “purified” refers to a cannabinoid that is separated from the plant matter from which it was derived.

Within the context of this disclosure, purified compounds may be purposely formulated with other compounds at various levels of purity. For example, depending on the desired outcome, a particular cannabinoid or terpene may be formulated with other molecules when it is 60-65% pure, 65-70% pure, 70-75% pure, 75-80% pure, 80-85% pure, 85-90% pure, 90-95% pure, 95-99% pure, 99-99.9% pure, 99.9+%, or greater than 99% pure. Provided that the ingredients used for purposeful formulation are purified prior to the said purposeful formulation, the act of subsequently formulating them does render them not “purified” within the context of an ingredient list.

In one embodiment, the compounds disclosed herein are purified by extracting the soluble compounds from plant material with ethanol. In one embodiment, the compounds disclosed herein are purified by chromatography techniques, such as supercritical fluid chromatography.

In one embodiment, the compositions disclosed herein comprise a second terpene.

In one embodiment, the compositions disclosed herein comprise a second cannabinoid.

In one embodiment, the sugar is chosen from sucrose, fructose, glucose, galactose, lactose, or maltose.

As used herein, the term “sucrose” refers to a compound of the following structural formula:

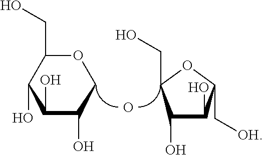

In one embodiment, sucrose is a disaccharide of glucose and fructose.

As used herein, the term “fructose” refers to a compound with the following chemical formula: C6H12O6. In one embodiment, fructose is derived from fruits. In one embodiment, fructose has the following structural formula:

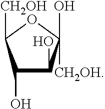

Within the context of this disclosure, the term “fructose” refers to any of the isomeric forms, e.g., open chain form, ring form, and any of the possible isomeric formations of those forms, etc.

As used herein, the term “glucose” refers to a compound with the following molecular formula: C6H12O6. Glucose is often characterized as circulating through the blood of animals. In one embodiment, glucose has the following structural formula:

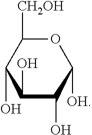

Within the context of this disclosure, the term “glucose” refers to any of the isomeric forms, e.g., open chain form, ring form, and any of the possible isomeric formations of those forms, etc.

As used herein, the term “galactose” refers to a compound with the following molecular formula: C6H12O6. Galactose is often characterized as a constituent of the disaccharide lactose. In one embodiment, galactose has the following structural formula:

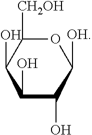

Within the context of this disclosure, the term “glucose” refers to any of the isomeric forms, e.g., open chain form, ring form, and any of the possible isomeric formations of those forms, etc.

As used herein, the term “lactose” refers to a compound with the following structural formula:

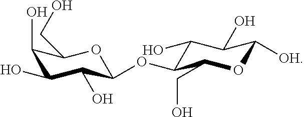

In one embodiment, lactose is derived from milk.

As used herein, the term “maltose” refers to a disaccharide formed from two glucose compounds. Within the context of this disclosure, the term maltose may refer to any compound from the various possible combination of bonds between two glucose compounds. In one embodiment, maltose has the following structural formula:

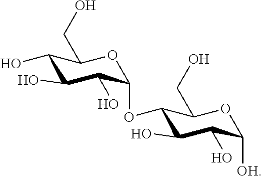

In one embodiment, maltose has the following structural formula:

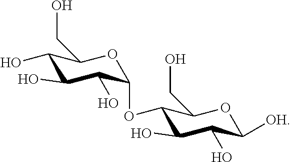

As used herein, the term “dry weight” refers to the mass of a certain compound (or compounds) relative to the entire mass of the entire sample after removing substantially all of the water. Any method suitable for attaining a dry weight and/or removing water is acceptable. Exemplary methods of removing water include using a dehydrator, oven, desiccant, and/or lamp.

In one embodiment, a plant is crushed and the number of structurally distinct compounds is determined. In one embodiment, the abundance, e.g., mass percent or number of compounds, of the sample is determined by techniques known in the art. Exemplary techniques for determining abundance, e.g., mass percent or number of compounds, include thin layer chromatography, high performance liquid chromatography, gas chromatography, gas chromatography mass spectrometry, supercritical fluid chromatography, etc.

In one embodiment, calculating dry weight comprises calculating the mass percent of a compound within a mixture with the following formula:

(Total mass of compound÷Total mass of sample after removing water)*100%

For example, the compound of interest is sugar (12 mg) and the total mass is 65 mg.

(12÷65)×100%=19%

Therefore, the sugar has a dry weight of 19%.

As used herein, the term “ratio” refers to proportions of a compound or compounds in relation to another compound or compounds.

In one embodiment, the shell comprises about 80%-100% sugar by mass percent.

In one embodiment, the shell comprises about 85%-100% sugar by mass percent.

In one embodiment, the shell comprises about 90%-100% sugar by mass percent.

In one embodiment, the shell comprises about 95%-100% sugar by mass percent.

In one embodiment, the shell comprises about 99%-100% sugar by mass percent.

In one embodiment, the shell comprises about 99.999%-100% sugar by mass percent.

In one embodiment, the acid is chosen from glucono delta-lactone, citric acid, ascorbic acid, acetic acid, lactic acid, malic acid, tartaric acid, potassium citrate, or sodium citrate.

As used herein, the term “glucono delta-lactone” refers to a compound with the following structural formula:

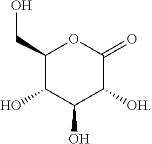 [SMILES: O=C1O[C@H](CO)[C@@H](O)[C@H](O)[C@H]1O]

Glucono delta-lactone is also referred to as “gluconolatone”. Glucono delta-lactone is often characterized as a sequestrant, an acidifier, or a curing, pickling, or leavening agent.

As used herein, the term “citric acid” refers to a compound with the following structural formula:

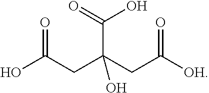 [SMILES: O=C(O)CC(O)(CC(=O)O)C(=O)O]

Citric acid naturally occurs in citrus fruits. Citric acid is often characterized as an acidifier and a flavoring and chelating agent.

As used herein, the term “ascorbic acid” refers to a compound of the following structural formula:

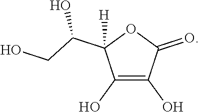 [SMILES: O=C1O[C@H]([C@@H](O)CO)C(O)=C1O]

Ascorbic acid is also commonly known as Vitamin C.

As used herein, the term “acetic acid” refers to a compound with the following structural formula:

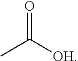

Acetic acid is often used as a chemical reagent for producing other chemical compounds. The largest single use of acetic acid is in the production of vinyl acetate monomer, closely followed by acetic anhydride and ester production. The volume of acetic acid used in vinegar is comparatively small.

As used herein, the term “lactic acid” refers to a compound with the following structural formula:

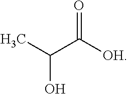

Lactic acid in a solid state is white and water-soluble. Lactic acid in a liquid state is clear. Lactic acid is produced both naturally and synthetically. Within the context of this disclosure, lactic acid comprises one of its chiral forms, a mixture, or a racemic mixture of all its forms.

As used herein, the term “malic acid” refers to a compound of the following structural formula:

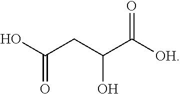

Malic acid is often characterized as a constituent of the Calvin Cycle. Within the context of this disclosure, the term “malic acid” may refer to either a single isomeric form or a racemic mixture.

As used herein, the term “tartaric acid” refers to a compound with the following structural formula:

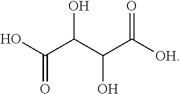

Within the context of this disclosure, the term “tartaric acid” may refer to either a single isomeric form or a racemic mixture.

As used herein, the term “potassium citrate” refers to a compound with the following structural formula:

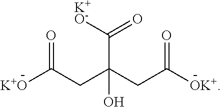

Potassium citrate appears as a white, hygroscopic crystalline powder. Potassium citrate is used as a food additive, e.g., regulating acidity.

As used herein, the term “sodium citrate” refers to a class of compounds of sodium salts of citrate.

In one embodiment, sodium citrate refers to monosodium citrate and has the following structural formula:

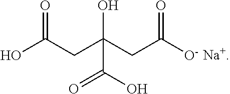

In one embodiment, sodium citrate refers to disodium citrate and has the following structural formula:

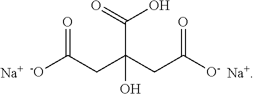

In one embodiment, sodium citrate refers to trisodium citrate and has the following structural formula:

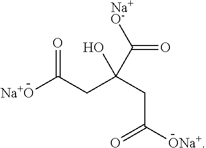

In one embodiment, the compositions disclosed herein comprise citric acid.

In one embodiment, the compositions disclosed herein comprise ascorbic acid.

In one embodiment, the acid serves as an effervescent.

In one embodiment, the base serves as an effervescent.

As used herein, the term “effervescent” refers to a compound causing the escape of gas from an aqueous compound. One visual sign of effervescence is bubbles or fizzing. In one embodiment, the effervescent is a base reacting with an acid.

In one embodiment, the base is chosen from MCO3 or MCO2H, wherein M is a metal.

As used herein, the term “MCO3” refers to a compound in which “M” is a metal balancing a carbonate.

As used herein, the term “carbonate” refers to the dianionic polyatomic compound with the following structural formula:

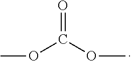

In one embodiment, the carbonate is decarboxylated releasing CO2 gas.

As used herein, the term “MCO2H” refers to a compound in which “M” is a metal balancing a bicarbonate.

As used herein, the term “bicarbonate” refers to a compound with the following structural formula:

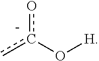

In one embodiment, the bicarbonate is decarboxylated releasing CO2 gas.

Within the context of this disclosure, the terms “MCO3” and “MCO2H” refers to salts which may react with acids causing effervescence.

In one embodiment, the compositions disclosed herein comprise a dry weight ratio of acid to base of about 1:1 to 25:1.

In one embodiment, the compositions disclosed herein comprise a dry weight ratio of acid to base of about 5:1 to 20:1.

In one embodiment, the compositions disclosed herein comprise a dry weight ratio of acid to base of about 10:1 to 15:1.

In one embodiment, the compositions disclosed herein comprise a dry weight ratio of acid to base of about 1:1 to 1:25.

In one embodiment, the compositions disclosed herein comprise a dry weight ratio of acid to base of about 1:5 to 1:20.

In one embodiment, the compositions disclosed herein comprise a dry weight ratio of acid to base of about 1:10 to 1:15.

In one embodiment, the compositions disclosed herein are three dimensional.

In one embodiment, the compositions disclosed herein are spherical.

As used herein, the term “spherical” refers to having the shape of a sphere. A sphere is a round three-dimensional object.

In one embodiment, the disclosed compositions are water soluble.

As used herein, the term “water soluble” refers to a substance dissolvable in water. Heating, stirring, shaking, mixing, etc. are examples of facilitating dissolving substances.

In one embodiment, the shell of the disclosed compositions comprises about 10-60% dry weight of the composition.

In one embodiment, the shell of the disclosed compositions comprises about 20-50% dry weight of the composition.

In one embodiment, the shell of the disclosed compositions comprises about 30-40% dry weight of the composition.

In one embodiment, the core of the disclosed compositions comprises about 30-80% dry weight Vitamin E TPGS.

In one embodiment, the core of the disclosed compositions comprises about 40-70% dry weight Vitamin E TPGS.

In one embodiment, the core of the disclosed compositions comprises about 50-60% dry weight Vitamin E TPGS.

### EXAMPLES

### Example 1

A composition was made with a shell and a core comprising cannabinoids in a spherical form.

The core was made with a cannabinoid, Vitamin E TPGS, an acid, and a base all in a powdered state. The powders were frozen and placed in a dessicator. The powders were then cryoground to form a homogeneous mixture. The powders were coated with hydroxypropyl cellulose (HPC).

A flavoring composition forming the shell was made with a similar method. Powdered forms of a sugar and flavoring agent were frozen and placed in a dessicator. The powders were then cryoground and made into a homogeneous mixture.

The core was made by rolling out the dried powders into a uniform sheet. A die was used to cut a proper dosage sample and shape. The cores were then misted with a HPC/ethanol solution and soft-panned in powdered HPC until evenly coated. The coated soft-cores were dried in a desiccation chamber.

The dried cores were soft-panned using the shell composition until the final table weight was obtained. The tablets were dried at ambient conditions.

### Example 2

A core was formed with Vitamin E TPGS, cannabinoid powder, citric acid, and baking soda. 35 mg of Vitamin E TPGS powder, 5 mg of cannabinoid powder comprising THC, 5 mg of citric acid powder, and 5 mg of baking soda were weighed. The dry powders were frozen separately and placed in a desiccator at −86 Celsius. The powders were then cryoground in a mortar and pestle to make a homogenous powder. The homogenous powder was then placed back in the desiccator and frozen at −86 Celsius. The homogenous powder was coated with HPC. The homogenous powder was then rolled out into a sheet. A round die was used to cut a core. The cores were then misted with 25% HPC/ethanol by w/w and soft-panned in powdered HPC until evenly coated. The coated soft-cores were dried for 48 hours in a desiccation chamber.

A flavor composition was made to form the shell. Dry powders of sucrose (5 mg), fructose (5 mg), and BB powder (1 mg) were frozen separately and placed in a desiccator at −86 Celsius. The powders were then cryoground in a mortar and pestle to make a homogenous powder. The homogenous powder was then placed back in the desiccator and frozen at −86 Celsius.

The dried cores were soft-panned using the flavor composition mixture at 60 rpm until the final table weight was obtained. Completed tablets were dried at ambient conditions for 48 hours before primary packaging with a desiccant.

The core weighed 50 mg, 82% by mass percent of the total composition. The shell weighed 11 mg, 18% by mass percent of the total composition.

### Example 3

A core was formed with Vitamin E TPGS, cannabinoid powder, citric acid, and baking soda. 35.7 mg of Vitamin E TPGS powder, 6.3 mg of cannabinoid powder comprising THC, CBD, CBC, CBG, CBN, THCV, and CBDV, 4.5 mg of citric acid powder, and 4.5 mg of baking soda were weighed. The dry powders were frozen separately and placed in a desiccator at −86 Celsius. The powders were then cryoground in a mortar and pestle to make a homogenous powder. The homogenous powder was then placed back in the desiccator and frozen at −86 Celsius. The powders were coated with HPC. The powders were then rolled out into a sheet. A round die was used to cut a core (5 mg). The cores were then misted with 25% HPC/ethanol by w/w and soft-panned in powdered HPC until evenly coated. The coated soft-cores were dried for 48 hours in a desiccation chamber.

A flavor composition was made to form the shell. Dry powders of sucrose (6 mg), fructose (6 mg), and BB powder (1 mg) were frozen separately and placed in a desiccator at −86 Celsius. The powders were then cryoground in a mortar and pestle to make a homogenous powder. The homogenous powder was then placed back in the desiccator and frozen at −86 Celsius.

The dried cores were soft-panned using the flavor composition powder mixture at 60 rpm until the final table weight was obtained. Completed tablets were dried at ambient conditions for 48 hours before primary packaging with a desiccant.

The core weighed 53 mg, 80% by mass percent of the total composition. The shell weighed 13 mg, 20% by mass percent of the total composition.

The above examples are for illustrative purposes only and are non-limiting.

Although the present invention herein has been described with reference to various exemplary embodiments, it is to be understood that these embodiments are merely illustrative of the principles and applications of the present invention. Those having skill in the art would recognize that various modifications to the exemplary embodiments may be made, without departing from the scope of the invention.

Moreover, it should be understood that various features and/or characteristics of differing embodiments herein may be combined with one another. In various embodiments, salts, acids, esters, ethers, stereoisomers, enantiomers, various alpha, beta, gamma, trans, cis, etc., forms are all disclosed as well. It is therefore to be understood that numerous modifications may be made to the illustrative embodiments and that other arrangements may be devised without departing from the scope of the invention.

Furthermore, other embodiments of the invention will be apparent to those skilled in the art from consideration of the specification and practice of the invention disclosed herein. It is intended that the specification and examples be considered as exemplary only, with a scope and spirit being indicated by the claims.

Finally, it is noted that, as used in this specification and the appended claims, the singular forms “a,” “an,” and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

What is claimed is:

1. A composition comprising:
a shell; wherein said shell comprises a sugar and a flavoring agent; and
a core; wherein said core comprises an acid, a base, Vitamin E TPGS, and a cannabinoid.

2. The composition of claim 1, comprising a second cannabinoid.

3. The composition of claim 1, comprising a terpene.

4. The composition of claim 3, comprising a second terpene.

5. The composition of claim 4, comprising a second cannabinoid.

6. The composition of claim 1, wherein the sugar is chosen from sucrose, fructose, glucose, galactose, lactose, or maltose.

7. The composition of claim 6, comprising sucrose.

8. The composition of claim 7, comprising fructose.

9. The composition of claim 8, comprising a dry weight ratio of sucrose to fructose of about 1:1.

10. The composition of claim 1, wherein the shell comprises 95% sugar by dry weight.

11. The composition of claim 1, wherein the acid is chosen from glucono delta-lactone, citric acid, ascorbic acid, acetic acid, lactic acid, malic acid, tartaric acid, potassium citrate, or sodium citrate.

12. The composition of claim 11, comprising citric acid.

13. The composition of claim 11, comprising ascorbic acid.

14. The composition of claim 1, wherein the base is chosen from MCO3 or MCO2H, wherein M is a metal.

15. The composition of claim 1, comprising a dry weight ratio of acid to base of about 1:1.

16. The composition of claim 12, wherein the cannabinoid is chosen from THC, CBD, CBC, CBG, CBN, THCV, or CBDV.

17. The composition of claim 3, wherein the terpene is chosen from Eucalyptol, Alpha-Pinene, Beta-Pinene, Alpha-Humulene, Limonene, Linalool, Nerolidol, Beta-Caryophyllene, Beta-Myrcene, Alpha-Terpineol, Terpinolene, Pulegone, Camphene, Delta-3-Carene, Geraniol, or Cymene.

18. The composition of claim 1, wherein the composition is spherical.

19. The composition of claim 1, wherein the composition is water soluble.

20. The composition of claim 1, wherein the shell comprises about 20% dry weight of the composition.

21. The composition of claim 1, wherein said core of said composition comprises about 50-60% dry weight Vitamin E TPGS.
